(19) United States
(12) Patent Application Publication
(10) Pub. No.: US 2009/0243882 A1
(43) Pub. Date: Oct. 1, 2009

(54) SYSTEM AND METHOD FOR A MANUALLY OPERATED VEHICULAR HAZARD WARNING SYSTEM

(76) Inventors: Willie Brown, San Francisco, CA (US); Khadijah B. Brown, San Francisco, CA (US)

Correspondence Address: Matlock Law Gfoup, PC;K. Brian Matlock, 1485 Treat Blvd., Suite #200, Walnut Creek, CA, 94597, US

(21) Appl. No.: 12/060,754

(22) Filed: Apr. 1, 2008

(51) Int. Cl. G08G 1/09

(52) U.S. Cl. 340/905

(57) ABSTRACT

A road hazard warning system provides a remote control and/or a turn signal-like on-steering wheel activation and engagement device, connected through an electronic interface, to cause a remote device to display a user-selected road hazard message. The device employs a CANCEL or OFF button on the remote control, or neutral position in an on-steering column stalk implementation, and/or an automatic cancellation feature after a given default time period, which provides for the cancellation of the currently-selected hazard and returns the display to a default state.

### CROSS-REFERENCES TO RELATED APPLICATIONS

NOT APPLICABLE.

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK

NOT APPLICABLE

### BACKGROUND OF THE INVENTION

The present invention relates in general to the existing vehicular signal devices such as taillights used to signal the vehicle's current maneuver, and in particular it relates to a manually-operated visual road hazard warning device attached to the rear of a vehicle and activated from within the cabin by a driver through remote control device, for purposes of warning other drivers behind the driver operating the device of a road hazard that may not be in their visual field.

All vehicles in the United States, as well as in many other countries, are required by law to be equipped with a set of lights in the rear of the vehicle that visually signal to other drivers when the vehicle's brakes are applied, when the driver intends to deviate from straight line motion, when the driver is backing up and when the vehicle's headlights are on. These requirements have evolved over time, often developed in response to traffic safety data. Certainly, they have greatly enhanced the safety of automobiles for their passengers as well as for pedestrians around them.

As the prevalence of the motor vehicle has grown, so has the population affected by their associated hazards. Likewise, their sphere of influence has grown to incorporate an ever-increasing set of common dangers. Brake lights have come to encompass so many levels of meaning, from simply slowing down by a small fraction of one's current speed, to braking hard before reaching a pothole or an object in the road, that it is sometimes difficult to glean important safety information for a particular situation from such an over-used signal.

Other systems have been proposed that use brake tap or stalk movement counts to indicate which one of a set of enumerated messages to display, some have proposed to use a grid of bulb-lit messages and some have proposed to receive, interpret and use the signals emitted from emergency vehicles and from standalone roadside equipment to alert only the operator of the vehicle so equipped of the meaning of the signal. These examples are problematic in their use and/or implementation, or they solve a different problem. The use of brake tap counts presents a very real safety hazard, which trailing vehicles are wont to misinterpret as the operator's intention to stop or slow down, or that they are signaling through courtesy taps that the person directly behind them needs to slow down to provide more road between the two cars, as is the convention. Further, this system is meant to be used in a crisis, and the likelihood of a driver in crisis successfully remembering how many taps to the brakes or clicks of the stalk mean which exact message to be displayed, on top of minding the crisis situation and keeping a tap count is low. It is also worth noting that having to rely on tapping the brakes when the brakes may need to be applied for slowing or stopping may very well create confusion for the driver and those behind him and thus, create more accidents than the system prevents. Systems for integration with a vehicle's turn signal flasher unit suffer from many of the same disadvantages. Additionally, turn signals are known to flash at different rates when components of the system are faulty; this would only serve to further confuse trailing drivers. Bulb-lit displays of previous systems have generally relied on text messages and/or very specific symbols. Reliance on either text or symbols presents a difficulty for trailing drivers. Remembering that the intent is to have all vehicles equipped with such a device, expecting drivers to simultaneously interpret multiple text messages and/or discern symbols from all vehicles in the milieu is not only an unreasonable expectation, but also takes the driver's attention away from the road and thus, again, is likely to cause more accidents than it prevents. GPS and onboard pattern recognition based systems, as well as systems that receive transmitted standard, coded hazard information do not solve the problem of a driver-operated signaling method and device by their very nature.

There is a definite need to extend the current repertoire of vehicular signals to encompass the most common of specific road hazards in a clear, concise manner that can be as universally recognizable as yellow turn signal lights and red brake lights. The present invention solves this need by providing for a manually-operated warning system with a controller used by the driver to select the immediate hazard, and a receiving and display unit that alerts other drivers behind the present vehicle.

### BRIEF SUMMARY OF THE INVENTION

The present invention provides a system, apparatus and method for selecting and displaying a specific visual warning to trailing drivers wherein a specific, color-coded road hazard type is selected from a preset group of hazard categories, causing the selection to be transmitted to and displayed on a display device in the rear of said vehicle until the display is canceled or until the preset display period is reached. Selections and cancellations can be initiated by a user or by an integrated, onboard hazard detection system.

In the case of a manually operated system, the selection and cancellation features are housed with their supporting electronics so as to be available to the driver within his or her reach in the cabin compartment of the motor vehicle, and each input is connected to the signal selector that determines the unique signal to be transmitted. Each specific visual hazard warning selection and the cancellation selection, or action in the case of an embodiment with an integrated hazard detection system, is associated with a unique signal and code.

A manually operated system can have a user interface in the familiar form of a push-button remote control, stalk embodiments including a windshield-wiper like control with movement in a single plane and a neutral position, or a headlight/turn signal-like control stalk with motion in two planes and a neutral position. A side view mirror controller-like rocker switch may also be employed as the user interface.

Illumination can be used to increase usability, such as illuminated buttons on a remote control or the use of a small electronic display on the rocker switch panel to indicate at a glance the current selection. Further, for any integrated embodiment, the currently selected visual hazard warning can be illuminated in a status light on the dashboard display, as is common with turn signals and “Check Engine” lights.

The transmitter and receiver portions of the disclosed invention can operate to communicate over a variety of carrier types and signal technologies, such as over a hardwired connection or via a wireless technology, such as IR (infrared) and radio frequency technologies such as Bluetooth.

Power can be supplied to all parts of the system by a variety of means including deriving power from the motor vehicle's electrical system, from a transformer connected to a cigarette lighter, from an adapter outlet as are becoming common in today's late model motor vehicles or from a common battery pack.

Each of the plurality of selectable visual road hazard warnings, and a neutral display, is associated with a unique signal from the selection and transmission system and apparatus that is in turn received by the receiver and display controller system and apparatus, where it is associated with a specific display configuration that a display controller communicates to the physical electronic color display mounted in the rear window, or alternatively in wireless embodiments on the roof of a motor vehicle in case of a roadside emergency. The housing for the receiver and display include all electrical components and power connections.

Power is conducted into the Fisher Price® logic game module through one or more electrical circuits which comprise one or more warning selection rules, while the speaker and mouse wires are simultaneously disconnected from the base of the Fisher Price® logic game module, subsequently receiving power from a car battery.

### BRIEF DESCRIPTION OF THE DRAWINGS

FIG. 1 is a control flow diagram depicting the overall behavior of the system once activated by the user.

FIG. 2 is functional diagram of the selection and transmission portions of the Applicant's invention.

FIG. 3 is a functional diagram of the receiving and display portions of the present invention.

FIG. 4 is a depiction of a remote control embodiment of the system interface.

FIG. 5 is a depiction of stalk embodiments of the system interface.

FIG. 6 is a depiction of rocker switch embodiments of the system interface

FIG. 7 shows illuminable dashboard display-based indicators associated with specific road hazard warnings.

FIG. 8 is a depiction of a blinking light circuit attached to a receiver

FIG. 9 shows a block diagram illustrating components of an exemplary operating environment.

FIG. 10 illustrates an exemplary computer system in which various embodiments of the present invention may be implemented.

FIG. 11 shows four embodiments of output hazard signal lights.

### DETAILED DESCRIPTION OF THE DRAWINGS

Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

References in the specification to “one embodiment,” “an embodiment,” “an example embodiment,” etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one of ordinary skill in the art to affect such feature, structure or characteristic in connection with other embodiments whether or not explicitly described. Parts of the description are presented using terminology commonly employed by those of ordinary skill in the art to convey the substance of their work to others of ordinary skill in the art.

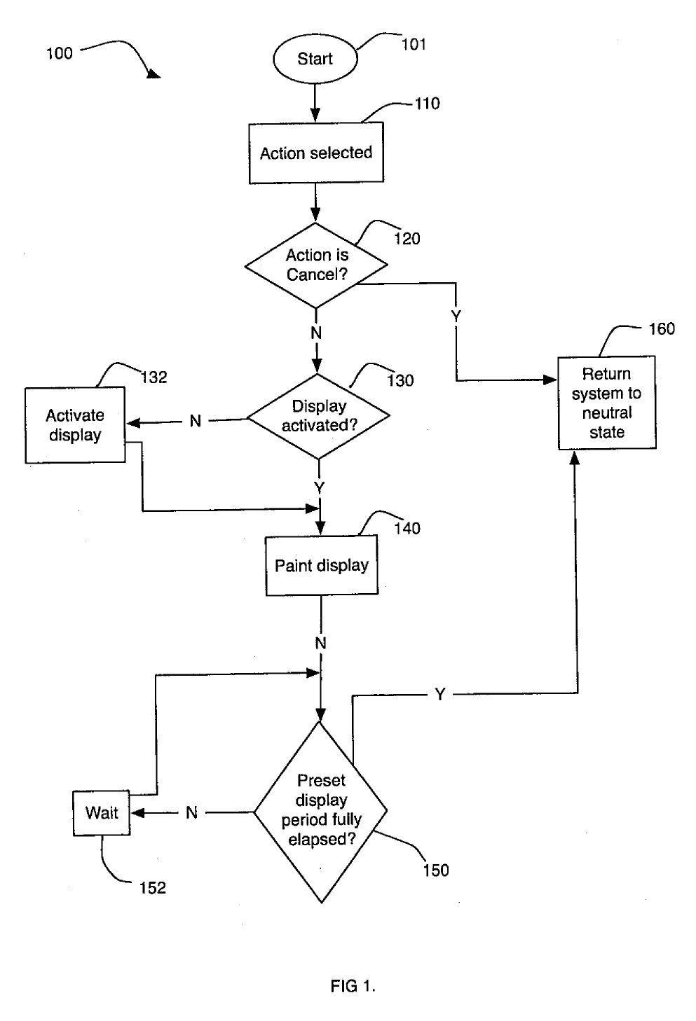

FIG. 1 is a control flow diagram illustrating the process of selecting 110 and displaying 140 a specific hazard warning using the present invention. A user manually selects 110 the specific hazard to be displayed. If the selection is 120 a specific road hazard warning, and the display is 130 already activated, the selected specific road hazard warning is painted 140 on the display unit. If the display unit is not 130 already activated, it is activated 132. If the selection is 120 a cancellation, the system including the state of the selection device and the display itself is returned 160 to a neutral state. Once the display is painted 140 with a specific road hazard warning, if the preset display period has not 150 fully elapsed, the system waits 152 and continues to display the recently selected specific road hazard warning. When the preset display period has 150 fully elapsed, the system including the state of the selection device and the display itself is returned 160 to a neutral state.

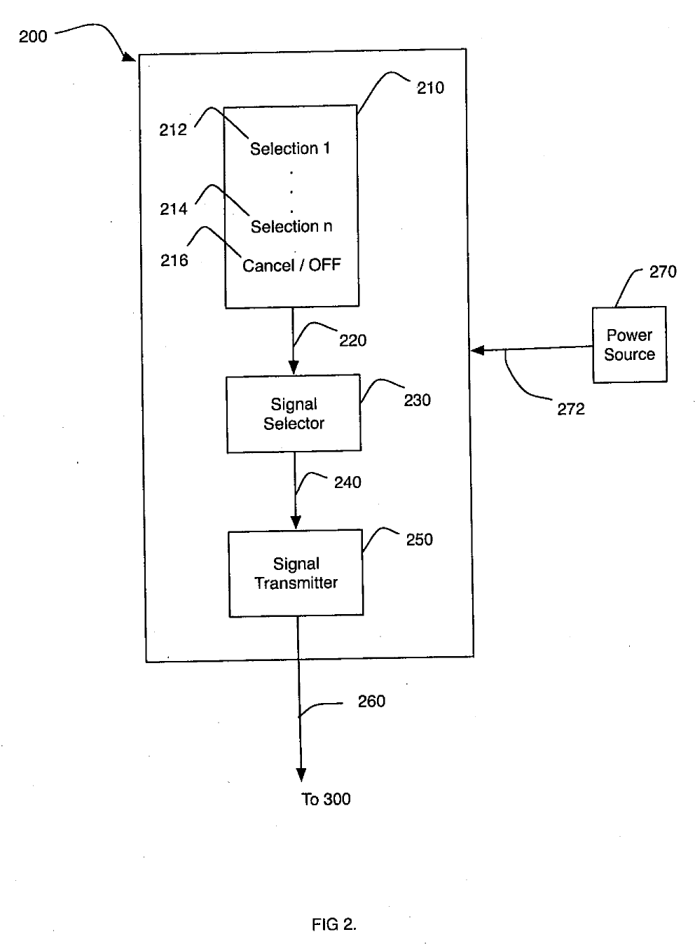

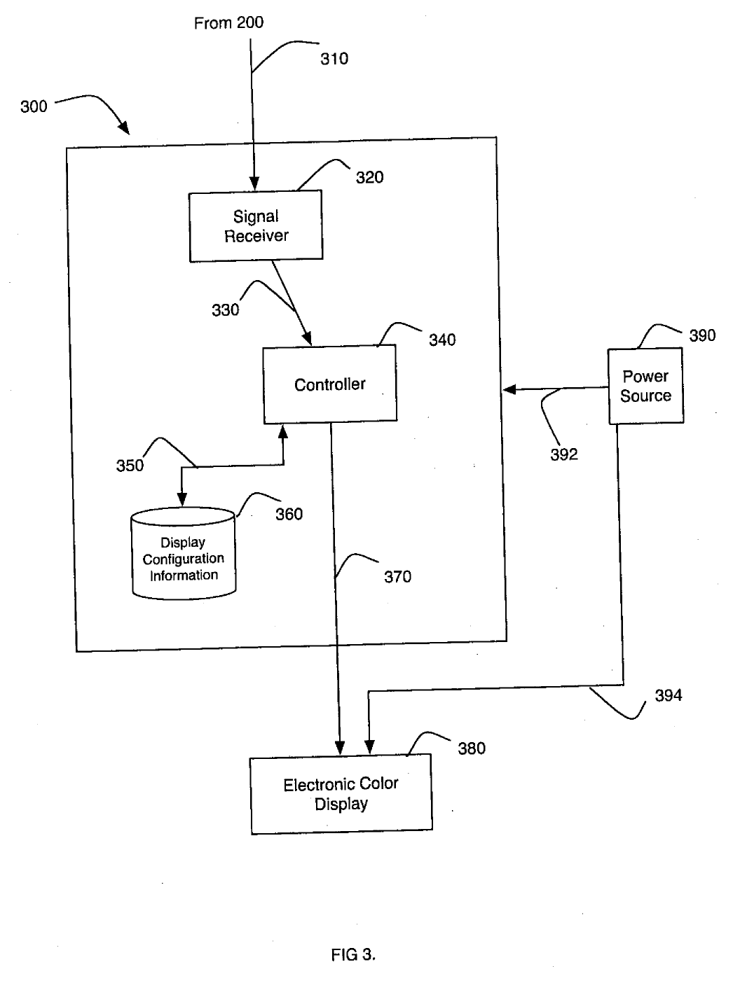

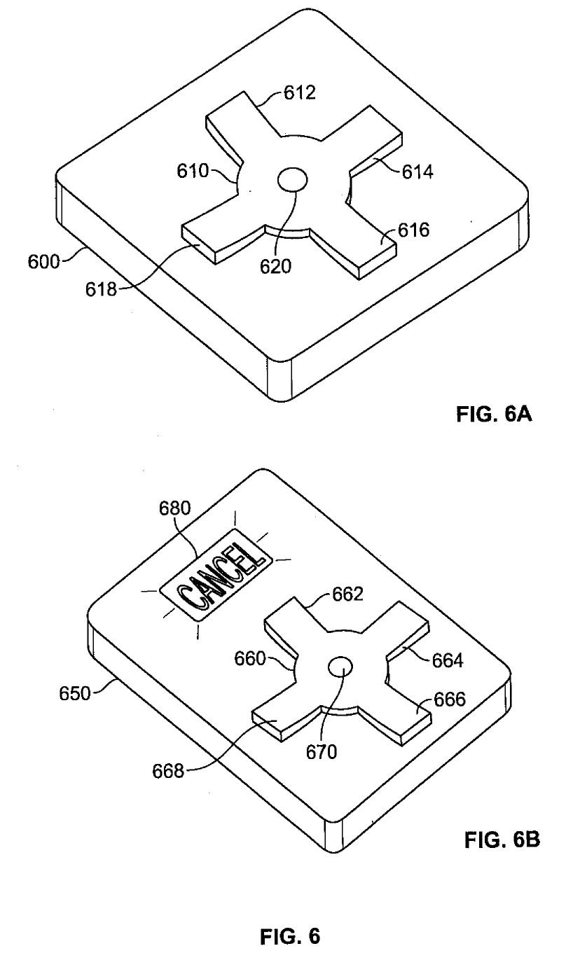

FIG. 2 is a functional diagram of the selection and transmission portions 200 of the Applicant's invention. The electronics in the selection and transmission system and apparatus 200 are powered by 272 a power source 270, the type of which depends upon the embodiment. A hand-held, user-installed aftermarket embodiment of the invention would require a battery pack. The power source 270 for a stalk embodiment or other integrated selection apparatus and system 200, such as a panel-based rocker switch (FIG. 6, 600, 650) or the integration with an onboard touch screen control system would require connection to the motor vehicle's electrical system and would derive power from that. An embodiment of the invention where, instead of input from a user, the input comes from an automated, onboard hazard detection system (see FIG. 1, 110) would also require connection to the motor vehicle's electrical system and thus would also derive power from it in that case. The system interface 210 for the selection 212, 214 and cancellation 216 of a warning to be displayed causes an action-specific signal 220 to be selected 230 that is relayed 240 to a signal transmitter 250. Said system interface 210 may be of a manual, user input type or may be an electrical or logical interface to an onboard, automated road hazard detection system. The signal transmitter 250 may be of different types, such as an IR (infrared) signal, common copper, or Bluetooth or other wireless technologies. The transmitter 250 generates an action-specific signal 260 to be received, interpreted and acted upon by the receiver unit (see FIG. 3, 300). It should be noted that while the system interface 210, the signal selector 230 and the signal transmitter 250 are represented in the functional diagram as one object, they each comprise a multiplicity of electronic components working together to provide their respective functionalities.

FIG. 3 is a functional diagram of the receiving 300 and display 380 portions of the present invention. The electronics in the receiver and display systems and apparatuses 300, 380 are powered by 392, 394 a power source 390, the type of which depends upon the embodiment. A user-installed aftermarket embodiment of the invention could require only a battery pack and no direct connection to the motor vehicle's electrical system for either the display 380 or the receiver 300. The power source 390 for an integrated system would require connection to the motor vehicle's electrical system and would derive power from that. The signal receiver 320 listens for action-specific signals 310 of the same type generated by the signal transmitter (see FIG. 2, 250). The receiver 320 then passes said signal 330 onto a display controller 340, which in turn accesses 350 the display configuration information 360 for that action, which is in turn passed 370 from the controller 340 to the display 380. The display configuration information 360 contains any color, array, timing and brightness parameters necessary to create a distinct visual road hazard warning display for the selected user action or a neutral display. Additionally, the controller 340 may contain a preset display period, after which a neutral display is invoked with no further prompting from the selection and transmission portion (see FIG. 2, 200) of the present invention. It should be noted that while the receiver 300, and its functional groups including the signal receiver 320, the controller 340, and the display configuration information 360, and the display 380, are all represented in the functional diagram as each being a single object, they each in implementation comprise a multiplicity of electronic components working together to provide their respective functionalities.

The display 380 is mounted in the rear of the motor vehicle facing trailing traffic. The display is physically mounted in the rear window area by snapping the housing in between the rear deck and window, or hanging by adhesive or suction. In wireless embodiments, particularly in an aftermarket, non-integrated user-installed embodiment, the display can be moved to the roof of the car in case of a roadside emergency, for instance.

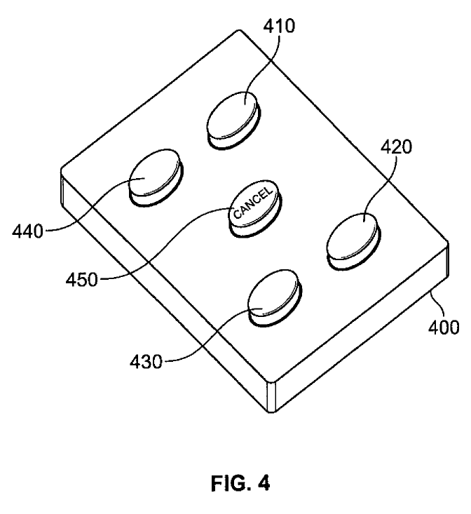

FIG. 4 is one embodiment of the system interface (see FIG. 2, 210), where the input is from a user through a remote control device 400. Remote control interfaces are well known in the art and thus, the design and construction of said device will not be discussed here. The user selects one of a multiplicity of specific hazard warnings to display by pressing the corresponding button 410, 420, 430, 440. The user can also elect to cancel a currently displayed warning before the default display duration has completely elapsed by pressing a button 450 that cancels the currently selected and displayed warning. It is worth noting that in aftermarket versions of this invention, the use of an IR- or Bluetooth-enabled remote control 400, coupled with a like-enabled receiver and display unit would provide users with a product that would work off the shelf with no installation other than mounting the rear-facing electronic color display

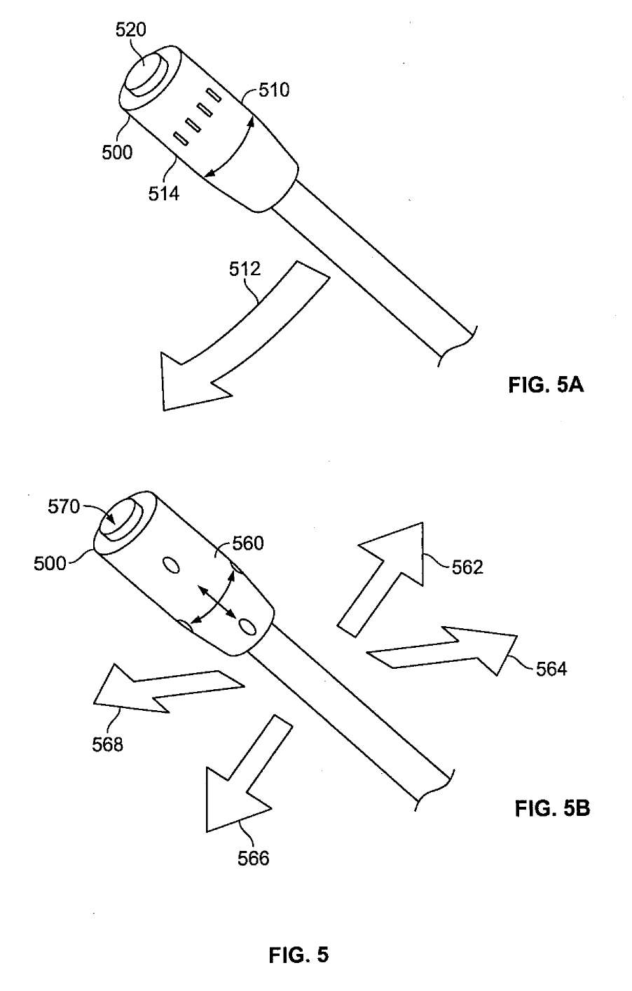

FIG. 5 depicts two more possible embodiments of the system interface (see FIG. 2, 210) that are similar, and are also designed for direct user input. FIG. 5A is an integrated stalk embodiment 500 with motion in one plane 512, such as is found implemented in windshield wiper control stalks in motor vehicles, and as such is well known in the art; therefore, the design and construction of stalk embodiments will not be discussed herein. The directional arrow 510 printed on the stalk indicates the plane of motion and the hash marks 514 indicate the plurality of positions corresponding to the different selectable hazard warning displays. The button 520 on top of the stalk is a possible design feature that could be pressed while initiating the planar motion 512 for selection, so that the selected position is not sent to the signal selector component 230 until the user has brought the stalk to its desired position and releases the button 520, thus increasing reliability of operation.

An alternate stalk embodiment is depicted in FIG. 5B, wherein instead of motion in a single plane, there is motion in two planes. The FIG. 5B integrated stalk embodiment 550 with motion in one plane in the up 562 and down 566 directions, and in a second plane in the back 568 and forth 564 directions, such as is found implemented in headlight/turn signal control stalks in motor vehicles. The directional arrows 560 printed on the stalk indicate the plurality of positions corresponding to the different selectable hazard warning displays. The button 570 on top of the stalk is a possible design feature that could be pressed while initiating the planar motion 562, 564, 566, 568 for selection, so that the selected position is not sent to the signal selector component 230 until the user has brought the stalk to its desired position and releases the button 570, thus increasing reliability of operation

FIG. 6 is yet another embodiment of the system interface (see FIG. 2, 210) of the present invention that is like a rocker switch, such as is found implemented in the integrated electrical controller for a side-view mirror in today's motor vehicles. FIG. 6A depicts the rocker panel 600 with the raised rocker switch 610, in this illustrative example having four possible specific hazard warning selections 612, 614, 616, 618 and a cancellation selection 620.

An alternate rocker switch embodiment is shown in FIG. 6B, wherein the rocker switch 660 mounted in the rocker panel 650 is augmented by the presence of an illuminated display 680, depicting the recently selected specific hazard warning selections 662, 664, 666, 668 or cancellation selection 670. The indicated display can be color-coded to match the color of each specific hazard warning display

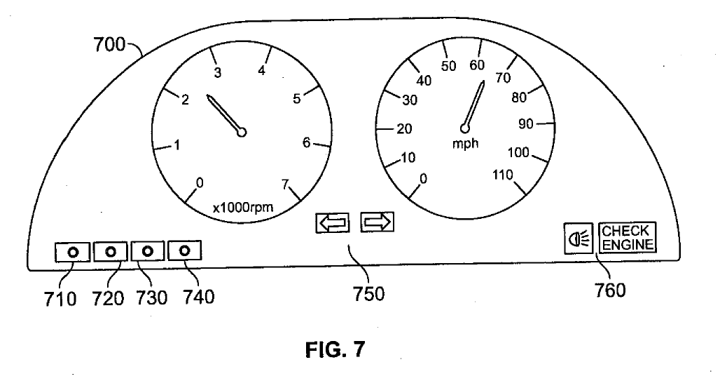

Finally, the selection can be displayed in dashboard lights for any integrated embodiment, just as turn signal indicators 750 and other status displays 760 are in today's motor vehicles. FIG. 7 shows again the example of four selectable specific hazard warnings 710, 720, 730, 740 depicted in separate, illuminable dashboard indicators on a generic dashboard 700. The dashboard indicators can be color-coded to match the color of each specific hazard warning display.

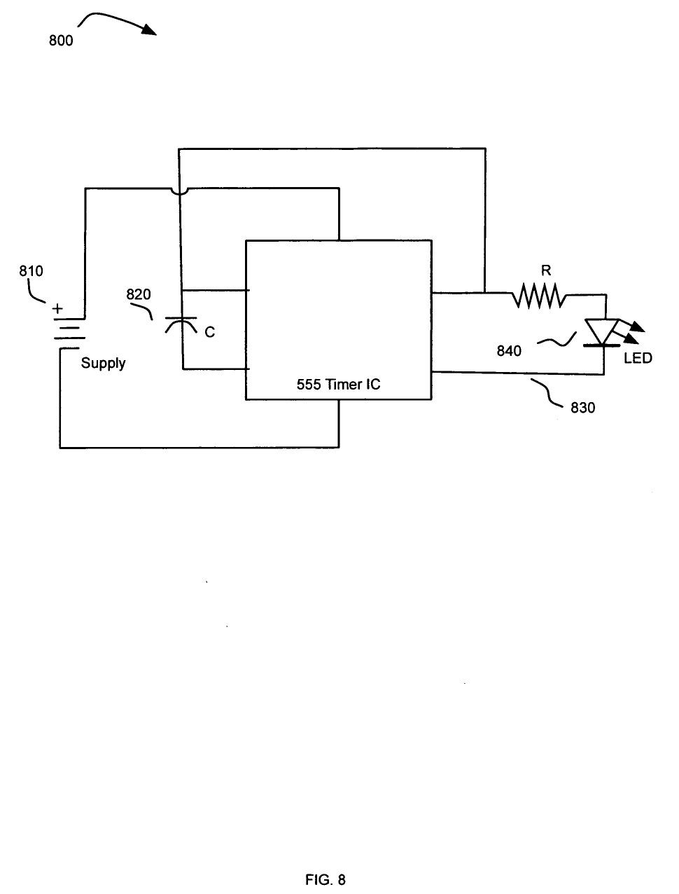

FIG. 8 depicts a blinking light circuit attached to a receiver. The circuit contains an integrated circuit 555 Timer in the center. Referring now to FIGS. 4, 5 and 6, the integrated circuit's timer causes the illuminated hazard signal displayed on the back of the motor vehicle to flash when the receiver detects a signal from the user interface. The circuit can be powered by one or two one and a half volt batteries 810. The circuit also contains a 300 μF capacitor 820 and a lead wire 830. The lead wire 830 is connected to the light emitting diodes (LEDs) 840 that display the desired output hazard signal.

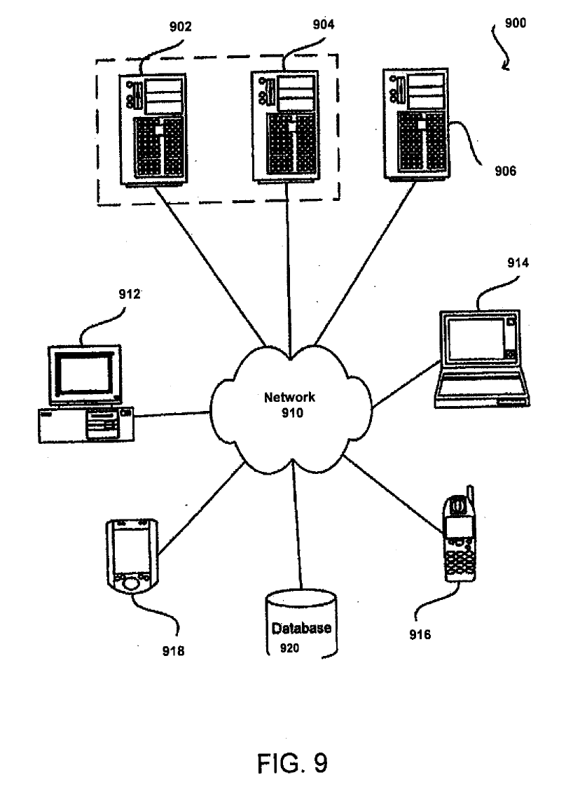

Exemplary Operating Environments, Components, and Technology FIG. 9 is a block diagram illustrating components of an exemplary operating environment in which various embodiments of the present invention may be implemented. The system 900 can include one or more user computers, computing devices, or processing devices 912, 914, 916, 918, which can be used to operate a client such as a dedicated application, web browser, etc. The user computers 912, 914, 916, 918 can be general purpose personal computers (including, merely by way of example, personal computers and/or laptop computers running a standard operating system), cell phones or PDAs (running mobile software and being Internet, e-mail, SMS, Blackberry, or other communication protocol enabled), and/or workstation computers running any of a variety of commercially-available UNIX or UNIX-like operating systems (including without limitation, the variety of GNU/Linux operating systems). These user computers 912, 914, 916, 918 may also have any of a variety of applications, including one or more development systems, database client and/or server applications, and Web browser applications. Alternatively, the user computers 612, 914, 916, 918 may be any other electronic device, such as a thin-client computer, Internet-enabled gaming system, and/or personal messaging device, capable of communicating via a network (e.g., the network 910 described below) and/or displaying and navigating Web pages or other types of electronic documents. Although the exemplary system 900 is shown with four user computers, any number of user computers may be supported.

In most embodiments, the system 900 includes some type of network 910. The network can be any type of network familiar to those skilled in the art that can support data communications using any of a variety of commercially-available protocols, including without limitation TCP/IP, SNA, IPX, AppleTalk, and the like. Merely by way of example, the network 910 can be a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 602.11 suite of protocols, GRPS, GSM, UMTS, EDGE, 2G, 2.5G, 3G, 4G, Wimax, WiFi, CDMA 2000, WCDMA, the Bluetooth protocol known in the art, and/or any other wireless protocol); and/or any combination of these and/or other networks.

The system may also include one or more server computers 902, 904, 906 which can be general purpose computers, specialized server computers (including, merely by way of example, PC servers, UNIX servers, mid-range servers, mainframe computers rack-mounted servers, etc.), server farms, server clusters, or any other appropriate arrangement and/or combination. One or more of the servers (e.g., 906) may be dedicated to running applications, such as a business application, a Web server, application server, etc. Such servers may be used to process requests from user computers 912, 914, 916, 918. The applications can also include any number of applications for controlling access to resources of the servers 902, 904, 906.

The Web server can be running an operating system including any of those discussed above, as well as any commercially-available server operating systems. The Web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers 912, 914, 916, 918. As one example, a server may execute one or more Web applications. The Web application may be implemented as one or more scripts or programs written in any programming language, such as Java®, C, C# or C++, and/or any scripting language, such as Perl, Python, or TCL, as well as combinations of any programming/scripting languages. The server(s) may also include database servers, including without limitation those commercially available from Oracle®, Microsoft®, Sybase®, IBM® and the like, which can process requests from database clients running on a user computer 912, 914, 916, 918.

The system 900 may also include one or more databases 920. The database(s) 920 may reside in a variety of locations. By way of example, a database 920 may reside on a storage medium local to (and/or resident in) one or more of the computers 902, 904, 906, 912, 914, 916, 918. Alternatively, it may be remote from any or all of the computers 902, 904, 906, 912, 914, 916, 918, and/or in communication (e.g., via the network 910) with one or more of these. In a particular set of embodiments, the database 920 may reside in a storage-area network (“SAN”) familiar to those skilled in the art. Similarly, any necessary files for performing the functions attributed to the computers 902, 904, 906, 912, 914, 916, 918 may be stored locally on the respective computer and/or remotely, as appropriate. In one set of embodiments, the database 920 may be a relational database, such as Oracle 1g that is adapted to store, update, and retrieve data in response to SQL-formatted commands.

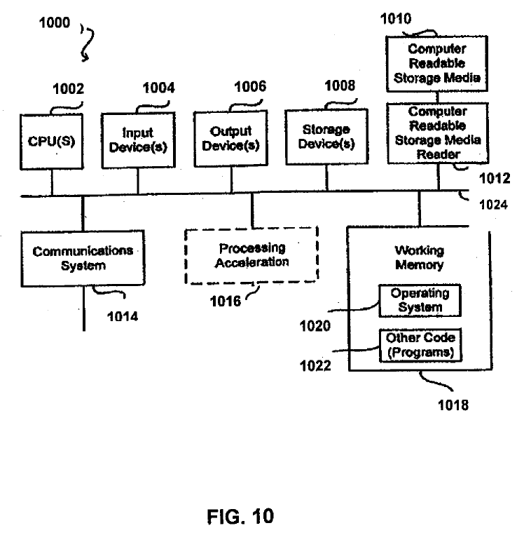

FIG. 10 illustrates an exemplary computer system 1000, in which various embodiments of the present invention may be implemented. The system 1000 may be used to implement any of the computer systems described above. The computer system 1000 is shown comprising hardware elements that may be electrically coupled via a bus 1024. The hardware elements may include one or more central processing units (CPUs) 1002, one or more input devices 1004 (e.g., a mouse, a keyboard, etc.), and one or more output devices 1006 (e.g., a display device, a printer, etc.). The computer system 1000 may also include one or more storage devices 1008. By way of example, the storage device(s) 1008 can include devices such as disk drives, optical storage devices, solid-state storage device such as a random access memory (“RAM”) and/or a read-only memory (“ROM”), which can be programmable, flash-updateable and/or the like.

The computer system 1000 may additionally include a computer-readable storage media reader 1012, a communications system 1014 (e.g., a modem, a network card (wireless or wired), an infra-red communication device, etc.), and working memory 99, which may include RAM and ROM devices as described above. In some embodiments, the computer system 1000 may also include a processing acceleration unit 1016, which can include a digital signal processor DSP, a special-purpose processor, and/or the like.

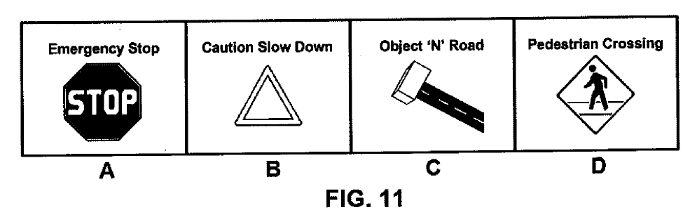

FIG. 11 depicts four embodiments of output hazard signal lights that can be displayed on the back of the motor vehicle, just as break lights and turn signals are displayed in today's motor vehicles. Referring to FIG. 7, the illuminated flashing warning signals can be displayed in different colors. FIG. 11A is an example of a general emergency stop warning signal and can have a stop sign symbol and corresponding red light. FIG. 11B shows another example of a general hazard warning signal displaying a caution, slow down sign and can be illuminated in yellow. FIG. 11C illustrates one embodiment of an object in the road warning sign. FIG. 11D illustrates a warning signal for pedestrians in the road, which may include a picture similar to the signs displayed at school crosswalks.

While the invention has been described by way of example and in terms of the specific embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method for selecting a specific visual warning to be displayed to trailing drivers wherein a specific, color-coded road hazard type is selected from a preset group of hazard categories, causing the selection to be transmitted to and displayed on a display device in the rear of said vehicle until the display is canceled.

2. The method of claim 1 wherein a currently-selected warning is canceled prior to reaching the preset display period.

3. The method of claim 1 wherein the warning is selected by a means selected from the group consisting of a user action and an automated hazard detection system.

4. An apparatus for the selection, cancellation and transmission of a specific visual warning in a motor vehicle which comprises:
a power source;
a plurality of color-coded warning selections, each selection associated with one and only one visual warning;
a cancellation selection;
a transmitting component to communicate said warning selection to a receiving and display apparatus;
a housing and mounting device for components of said warning and cancellation selection, associated electronic circuits and transmission components; and
a warning selection device that produces a unique output signal corresponding only to the selected warning to be displayed.

5. The apparatus of claim 4 wherein said power source is selected from a group consisting of an electrical connection to the electrical system of said motor vehicle; a transformer deriving delivered power from the cigarette lighter of said motor vehicle; and a DC power source not coupled to the electrical system of said motor vehicle.

6. The apparatus of claim 4 wherein one or more electrical circuits power a Fisher Price® logic game module comprising one or more warning selection rules; one or more electrical circuits regulate the power source; and speaker wires and mouse wires disconnect from the base of the Fisher Price® logic game module to subsequently receive power from a car battery.

7. The apparatus of claim 4 wherein cancellation selection device produces a unique output signal corresponding to a neutral display mode.

8. The apparatus of claim 4 further comprising a signal transmission device comprising:
an input comprising connections to each selection device;
a logic circuit associating the input to a unique output signal; and
an output signal generator and carrier device selected from the group consisting of a wireless transmitter and its associated carrier frequency; and an electrical component producing a modulated signal carried over physical electrical connection.

9. The apparatus of claim 4 wherein said warning selection and transmission means and their associated circuitry are housed so that the warning selection and cancellation devices are accessible by the driver in the cabin of the motor vehicle.

10. An apparatus for receiving signals carrying information on the selected warning to be displayed; warnings to be cancelled; displaying signals for specific visual warnings and the cancellation of said warnings in a motor vehicle which comprises:
a power source;
an electronic color display;
a receiving component to receive a multiplicity of signals;
a logic circuit relating said received signal to a specific function;
devices capable of storing and accessing cancellation functions and plurality of visual display configurations and functions; and
a housing and mounting device for said receiving and electronic display components.

11. The apparatus of claim 10 wherein said power source is selected from a group consisting of an electrical connection to the electrical system of said motor vehicle; a transformer deriving delivered power from the cigarette lighter of said motor vehicle; and a DC power source not coupled to the electrical system of said motor vehicle.

12. The apparatus of claim 10 wherein said electronic color display is connected to the receiving unit and power source, and wherein the visual display configuration is controlled by devices in the receiving unit capable of storing and accessing cancellation functions and plurality of visual display configurations and functions.

13. The apparatus of claim 10 further comprising a signal reception device comprising:
an input device that listens for a discrete set of signals selected from the group consisting of a wireless transmitter and its associated carrier frequency; an electrical component carrying a modulated signal over physical electrical connection;
a logic circuit associating the input to a unique display configuration; and
an output signal generator electrically connected to a logic circuit that provides cancellation functions, and a plurality of visual display configurations and functions to the display screen.

14. The apparatus of claim 10 wherein the display, the receiver and their associated circuitry are housed so that the display is mountable on the rear windshield of a motor vehicle.

15. The apparatus of claim 10 wherein the display can be mounted on the roof of a motor vehicle.

16. A system for the selection, cancellation and transmission of a specific visual warning in a motor vehicle which comprises:
an electronic device for the selection of a plurality of specific visual warnings and the cancellation of said warnings;
a second electronic device in communication with the first electronic device wherein the second electronic device receives a signal from the first electronic device comprising a display configuration selection to be transmitted to a remote receiver system and apparatus; and
a third electronic device in communication with the second electronic device wherein the third electronic device transmits a unique signal to said remote receiver system and apparatus

17. The system of claim 16 wherein the first electronic device is a push-button remote control interface.

18. The system of claim 17 wherein said push buttons are illuminated.

19. The system of claim 16 wherein the first electronic device is a stalk with a neutral position and a plurality of selection positions.

20. The system of claim 16 wherein the first electronic device is a rocker switch with a neutral position and a plurality of selection positions.

21. The system of claim 20 wherein the rocker switch is associated with an electronic display indicating the currently selected display.

22. The system of claim 16 wherein the first electronic device is an interface to an automated, integrated hazard detection system and apparatus.

23. The system of claim 16 wherein the third electronic device transmits by a signal type selected from a group comprising infrared frequency waves, radio frequency waves and over a wire connected to the remote receiver system and apparatus.

24. A system for receiving signals carrying information regarding the selected warning to be displayed; warnings to be cancelled; displaying signals for specific visual warnings and the cancellation of said warnings in a motor vehicle which comprises:
an electronic device for the reception of a signal indicating the device display configuration;
a second electronic device in communication with the first electronic device wherein the second electronic device receives a signal from the first electronic device comprising a unique signal indicating the currently selected device configuration and wherein the second device retrieves the display configuration information stored on a third electronic device;
a third electronic device in communication with the second electronic device wherein the third electronic device stores and returns the color, intensity and pattern and timing unique to a specific visual warning and a neutral display; and
a fourth electronic device in communication with the second electronic device wherein the fourth electronic device is an electronic color display capable of displaying a specific visual warning as described by the display configuration information provided by the third electronic device.

25. The system of claim 24 wherein the first electronic device receives a signal by a means selected from a group comprising infrared frequency waves, radio frequency waves and over a wire connected to the remote receiver system and apparatus.
